(19) United States
(12) Patent Application Publication
(10) Pub. No.: US 2014/0177562 A1
(43) Pub. Date: Jun. 26, 2014

(54) METHOD AND APPARATUS FOR IMPLEMENTING NEW CARRIER TYPE (NCT) IN A WIRELESS COMMUNICATION SYSTEM

(71) Applicant: INNOVATIVE SONIC CORPORATION, Taipei City (TW)

(72) Inventor: Ming-Che Li, Taipei City (TW)

(73) Assignee: INNOVATIVE SONIC CORPORATION, Taipei City (TW)

(21) Appl. No.: 14/141,032

(22) Filed: Dec. 26, 2013

Related U.S. Application Data
(60) Provisional application No. 61/745,901, filed on Dec. 26, 2012.

(51) Int. Cl. H04L 5/00

(52) U.S. Cl. CPC H04L 5/0053
USPC 370/329

(57) ABSTRACT

A method and apparatus for implementing New Carrier Type (NCT) are disclosed. The method includes including a PDCCH (Physical Downlink Control Channel) for a standalone NCT in part of DL (Downlink) bandwidth, wherein bandwidth for the PDCCH is indicated in a MIB (Master Information Block) field. In one embodiment, the method includes demodulating the PDCCH using the reduced CRS within the indicated bandwidth for the PDCCH.

### CROSS-REFERENCE TO RELATED APPLICATIONS

The present Application claims the benefit of U.S. Provisional Patent Application Ser. No. 61/745,901 filed on Dec. 26, 2012, the entire disclosure of which is incorporated herein by reference.

### FIELD

This disclosure generally relates to wireless communication networks, and more particularly, to a method and apparatus for implementing NCT in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus for implementing New Carrier Type (NCT) are disclosed. The method includes including a PDCCH (Physical Downlink Control Channel) for a standalone NCT located in part of DL (Downlink) bandwidth, wherein bandwidth for the PDCCH is indicated in a MIB (Master Information Block) field. In one embodiment, the method includes demodulating the PDCCH using the reduced CRS within the indicated bandwith for the PDCCH.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a flow chart according to one exemplary embodiment.

FIG. 6 is a flow chart according to one exemplary embodiment.

FIG. 7 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. RP-121415, “New WI proposal: New Carrier Type for LTE”, Ericsson, ST-Ericsson; R1-120001, “Final Report of 3GPP TSG RAN WG1 #67 v1.0.0”; R1-122892, “Final Report of 3GPP TSG RAN WG1 #68bis v1.1.0”; TS 36.211 V11.0.0, “E-UTRA Physical Channels and Modulation (Release 11)”; and TS 36.331 V11.1.0, “E-UTRA Radio Resource Control (RRC) (Release 11)”. The standards and documents listed above are hereby expressly incorporated herein.

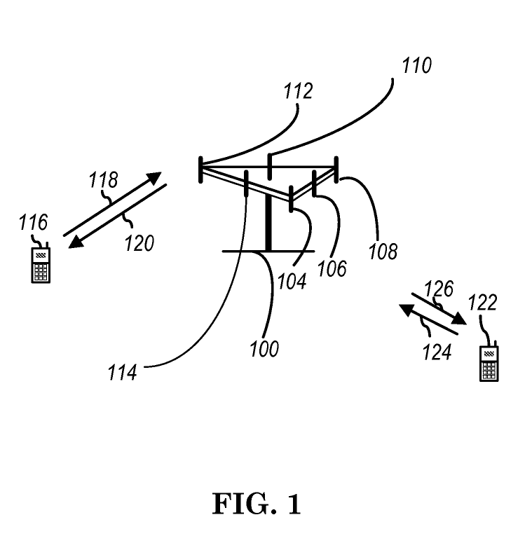

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

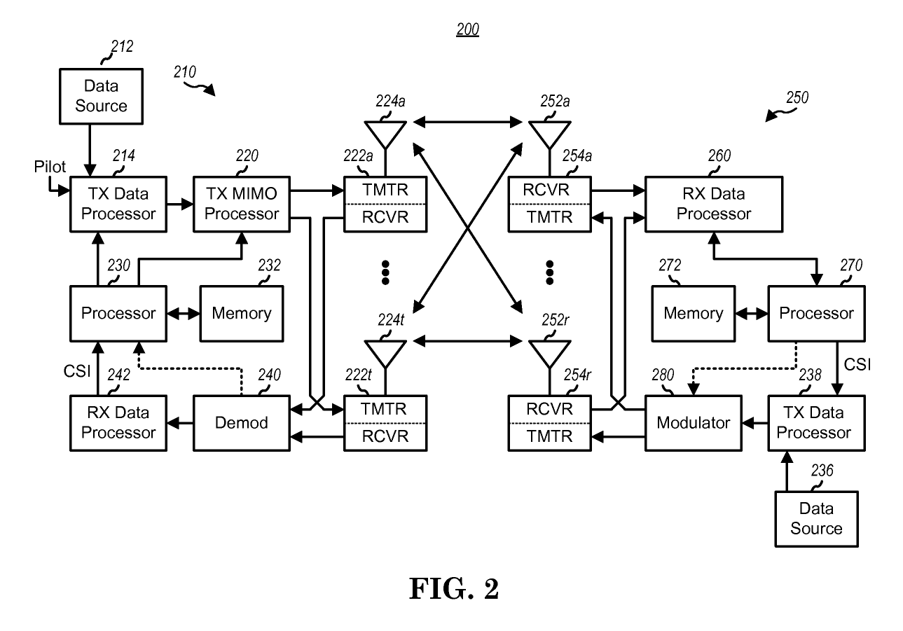

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

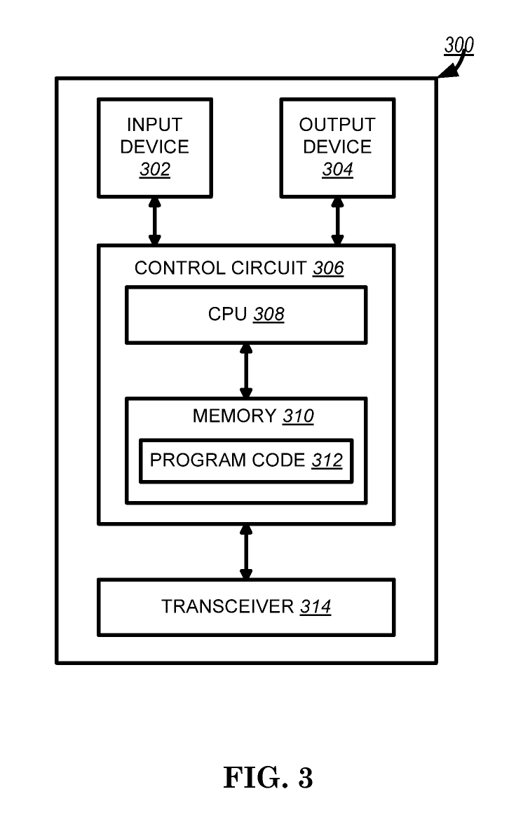

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

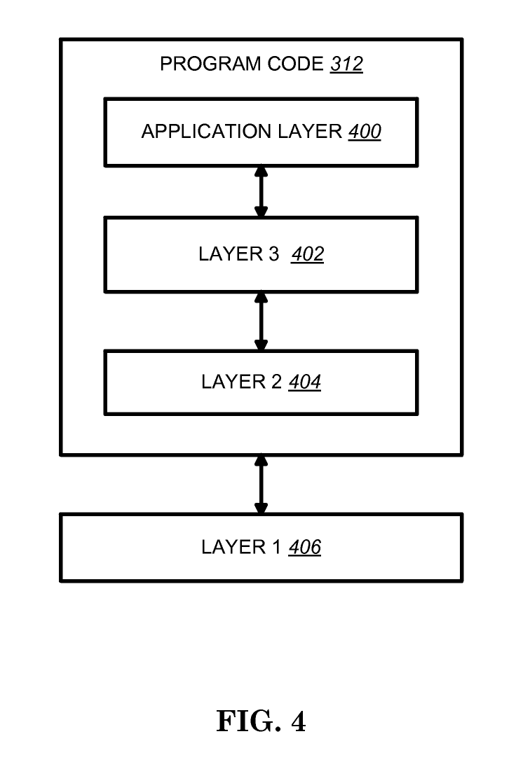

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

In RAN 57 meeting, a study item (discussed in 3GPP RP-121415) for New Carrier Type (NCT) was approved as follows:

The objective of the work item is the following:
In a first phase specify the New Carrier Type being aggregated with a legacy LTE carrier.
Specify necessary enhancements for transmission of data and control as well as the necessary UE mobility support on the New Carrier Type.
   In a second phase specify enhancements to the New Carrier Type also considering the findings of the small cell related Rel-12 studies (from RAN#60)
Specify necessary means to allow standalone and macro-assisted operation on the New Carrier Type, including
   A broadcast mechanism to acquire system information, a common search space for ePDCCH and UE mobility support.
   If justified by the small cell related studies, specify necessary means to support a dual dormant/active state, which means DTX like eNB behaviour (with long DTX cycles) and corresponding UE procedures, with or without reduced CRS in the active state.
Verify the suitability of the solutions specified in the first phase for the purposes of standalone New Carrier Type operations and small cells and update the necessary functionalities and signals if necessary.
Specify corresponding UE and eNB core requirements

Furthermore, in RAN1 #67 (as discussed in 3GPP R1-120001, the design of the new carrier type are considered for the two scenarios (including Synchronized carriers and Unsynchronized carriers), which depend on whether the legacy and additional carriers are synchronized in time and frequency to the extent that no separate synchronization processing is needed in the receiver.

In RAN1 #68bis (as discussed in 3GPP R1-122892), it is agreed that Rel-8 PSS/SSS sequences are transmitted and, at least for the unsynchronized case, a reduced CRS with one port and 5 ms periodicity is utilized for time and frequency tracking and RSRP measurement. More specifically, 3GPP R1-122892 states:

Agreement (at least for the unsynchronised case):
New carrier type can carry 1 RS port (consisting of the Rel-8 CRS Port 0 REs per PRB and Rel-8 sequence) within 1 subframe with 5 ms periodicity
   This RS port is not used for demodulation
   FFS how RSRP measurements would then be handled for the NCT
      Ask RAN4 for guidance on RRM measurement handling
   BW is FFS until RAN1#69 between one of:
      full system BW
         Objections to removing: CATT, NTT Docomo, Mediatek, Intel, NSN, Nokia, CMCC, Samsung, LGE, Qualcomm, Motorola Mobility, Ericsson, ST-Ericsson
      min(system BW, X) where X is selected from {6, 25}RBs
         Ask RAN4 for guidance on which BW
         Objections to removing: Fujitsu, Huawei, HiSilicon, ALU, ASB, NEC, NTT Docomo, ZTE
      configurable between full system BW and min(system BW, X)
         Objections to removing: Huawei, HiSilicon
            Mr Chair drew the following conclusion:
The working assumption is agreed: Rel-8 PSS/SSS sequences are transmitted.

As described in 3GPP TS 36.211 V11.0.0, the design of the Secondary Synchronization Signal (SSS) are composed by two sequences s₀^{(m}^{₀}⁾(n) and s₁^{(m}^{₁}⁾(n), where m₁>m₀. The two values m₁ and m₀ decides the value of N_{ID}⁽¹⁾ as defined in Table 6.11.2.1-1 of 3GPP TS 36.211 V11.0.0, where the physical layer cell identity N_{ID}^{cell}=3N_{ID}⁽¹⁾+N_{ID}⁽²⁾. The physical layer cell identity is used to derive the scrambling sequence for the bits transmitted on the physical broadcast channel as described in Section 6.6.1 of 3GPP TS 36.211 V11.0.0. The physical broadcast channel delivers the Master Information Block (MIB), as discussed in 3GPP TS 36.331 V11.1.0. More specifically, 3GPP TS 36.331 V11.1.0 provides the following description of the Master Information Block:

MasterInformationBlock

-- ASN1START

| | |
|---|---|
| MasterInformationBlock ::= | SEQUENCE { |

| | |
|---|---|
| dl-Bandwidth | ENUMERATED { |

n6, n15, n25, n50, n75, n100},

| | |
|---|---|
| phich-Config | PHICH-Config, |
| systemFrameNumber | BIT STRING (SIZE (8)), |
| spare | BIT STRING (SIZE (10)) |

}
-- ASN1STOP

Currently, when a UE attempts to camp on a cell, the UE needs to detect PSS (Primary Synchronization Signal)/SSS (Secondary Synchronization Signal), decode PBCH (Physical Broadcast Channel) to monitor PDCCH and then acquire system information. Firstly, the PSS/SSS detection would help the UE to synchronize in the frequency and time domain and also to get the physical layer cell identity. Then, the UE would attempt to decode PBCH with demodulation by CRS (Cell-specific Reference Signal). The MIB delivered on PBCH would inform the UE about the DL (Downlink) bandwidth configuration, the PHICH (Physical Hybrid ARQ Indicator Channel) configuration, and the system frame number. With the PHICH configuration, the UE could start to monitor PDCCH Common Search Space (CSS) to acquire SIB1 (System Information Block 1) and SIB2 (System Information Block 2).

Considering the case of standalone NCT (New Carrier Type), since there is no associated backward-compatible carrier, PSS/SSS and reduced CRS would need to be transmitted for time and frequency synchronization. Currently, it has not been decided that which subframes should be utilized to transmit the reduced CRS. If the reduced CRS is transmitted in subframe 0, it would be possible for UE to decode PBCH demodulated by the one-port reduced CRS. Then the UE could just follow the legacy procedure to detect PSS/SSS and decode PBCH.

Regarding the SIB acquisition, there are at least two ways to receive the DL assignment (including monitoring PDCCH CSS or EPDCCH CSS) as follows:

DL assignment for SIB is delivered via PDCCH—Since DM-RS (DeModulation Reference Signal) is not located on the OFDM (Orthogonal Frequency Division Multiplexing) symbols of legacy control region, reduced CRS would be the way to demodulate PDCCH unless a new reference signal is designed. Since the reduced CRS transmission may cover only part of DL bandwidth, it would restrict the PDCCH region.
DL assignment for SIB is delivered via EPDCCH—To let the UE monitor EPDCCH (Enhanced Physical Downlink Control Channel) in the stage of SIB acquisition, some indications to indicate standalone NCT and the resources for EPDCCH CSS are needed beforehand.

On the other hand, if the reduced CRS is not allowed to demodulate PBCH, demodulation could be performed via DM-RS. Before UE gets any information about cell type, standalone NCT or legacy backward-compatible carrier, the UE may need to blindly decode PBCH demodulated by CRS and by DM-RS. Additional decoding overhead would be need for such blind decoding.

One possible way is to include the cell type indication in PSS/SSS. Currently, some companies proposed to change the relative location of PSS/SSS to avoid the collision with DM-RS. Such change could help UE know the cell type as well. However, additional decoding overhead would still be needed.

To help the UE camp on a standalone NCT, some indication would be needed to indicate that the camped cell is a standalone NCT. Before getting such indication, the UE would follow the current behavior. After getting the information of the cell type, the UE could start to perform some behavior of the NCT, such as monitoring EPDCCH (Enhanced Physical Downlink Control Channel) CSS or demodulation by DM-RS. There are at least three ways to get the indication of the standalone NCT:

1. SIB—Before the UE acquires SIB and get the information of NCT, the UE could just follow the current behavior. Since the region of PDCCH demodulated by reduced CRS may cover only part of DL bandwidth, the DL bandwidth field in MIB (i.e., dl-Bandwidth) would indicate the bandwidth for PDCCH CSS monitoring. Thus, the UE would monitor and demodulate PDCCH CSS by reduced CRS within the indicated bandwidth. After acquiring the SIB, the UE would get the cell DL bandwidth configuration and/or the information of EPDCCH CSS. Furthermore, the PCFICH and/or PHICH transmission would also be limited in the bandwidth of the reduced CRS.
2. PBCH—The cell type information could be explicitly included in the MIB or implicitly derived by the PBCH decoding. For instance, the standalone NCT and the backward-compatible carrier could utilize different scrambling sequences even though their physical layer cell identities are the same. With the cell type information, some information about EPDCCH CSS could be included in MIB of the standalone NCT to help the UE obtain the DL assignments. Furthermore, the current field of PHICH configuration (i.e., phich-Config) could be re-utilized to deliver the information of EPDCCH CSS.
3. Synchronization signal—As discussed in 3GPP TS 36.331 V11.1.0, the physical layer cell identity is determined by N_{ID}⁽¹⁾ and N_{ID}⁽²⁾, and the physical layer cell identity group N_{ID}⁽¹⁾ has one-to-one mapping to the indices (m₁,m₀) of SSS ( ). A new mapping between N_{ID}⁽¹⁾ and t he indices (m₁,m₀) could be defined for the standalone NCT. For example, the standalone NCT and the legacy backward-compatible carrier would be mapped to different value regions of the indices (m₁,m₀). Therefore, even if a standalone NCT has the same physical layer cell identity with a backward-compatible carrier, their mapped indices (m₁,m₀) would be different. Thus, the UE could get the physical layer cell identity from the PSS/SSS and could also identify the cell type of the camped cell. If the camped cell is the standalone NCT, the UE could demodulate PBCH by DM-RS and could monitor EPDCCH CSS to acquire system information afterward.

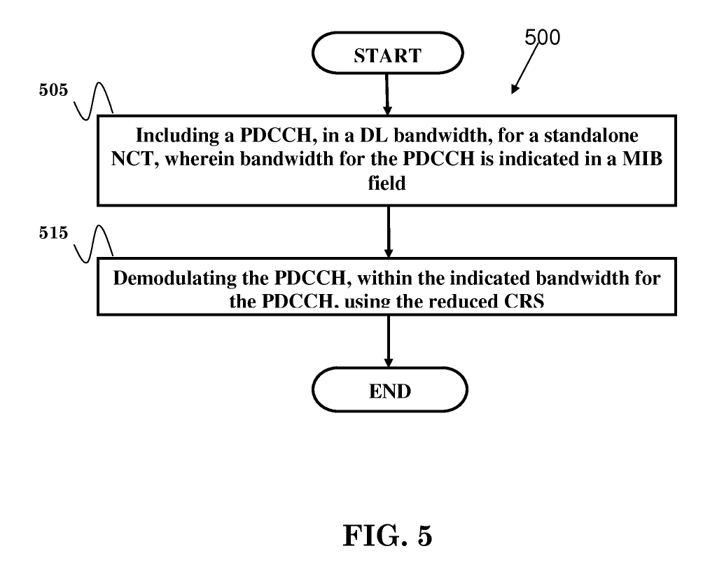

FIG. 5 is a flow chart 500 in accordance with one exemplary embodiment. In step 505, a PDCCH is included, in part of DL bandwidth, for a standalone NCT, wherein bandwidth for the PDCCH is indicated in a MIB field. In one embodiment, the DL bandwidth configuration of the standalone NCT is included in a SIB (System Information Block). In one embodiment, the SIB indicates the cell type (i.e., standalone NCT or backward-compatible carrier). Furthermore, the SIB could be SIB1 or SIB2.

In one embodiment, the MIB field is dl-Bandwidth. Furthermore, the resource-mapping of PCFICH (Physical Control Format Indicator Channel) could be derived by the bandwidth of the PDCCH region instead of DL bandwidth configuration of the standalone NCT. In addition, the number of PHICH (Physical Hybrid ARQ Indicator Channel) groups could be derived by the bandwidth of the bandwidth of the PDCCH region instead of DL bandwidth configuration of the standalone NCT. Also, the PHICH transmission would be within the bandwidth of the PDCCH region. In one embodiment, the PDCCH region exists only in subframes 0 and/or 5.

In step 515, the PDCCH is demodulated, within the indicated bandwidth for the PDCCH, using the reduced CRS. In one embodiment, the reduced CRS is transmitted in subframes 0 and/or 5.

Referring back to FIGS. 3 and 4, in one embodiment, the device 300 could include a program code 312 stored in memory 310 to implement NCT. In one embodiment, the CPU 308 could execute the program code 312 to enable a first UE (i) to include a PDCCH for a standalone NCT in part of DL bandwidth, (ii) to indicate bandwidth for the PDCCH in a MIB (Master Information Block) field, (iii) to transmit a reduced CRS (Cell-specific Reference Signal) within a region of the PDCCH, and (iv) to demodulate the PDCCH using the reduced CRS within the indicated bandwith for the PDCCH. In addition, the CPU 308 could execute the program code 312 to perform all of the above-described actions and steps or others described herein.

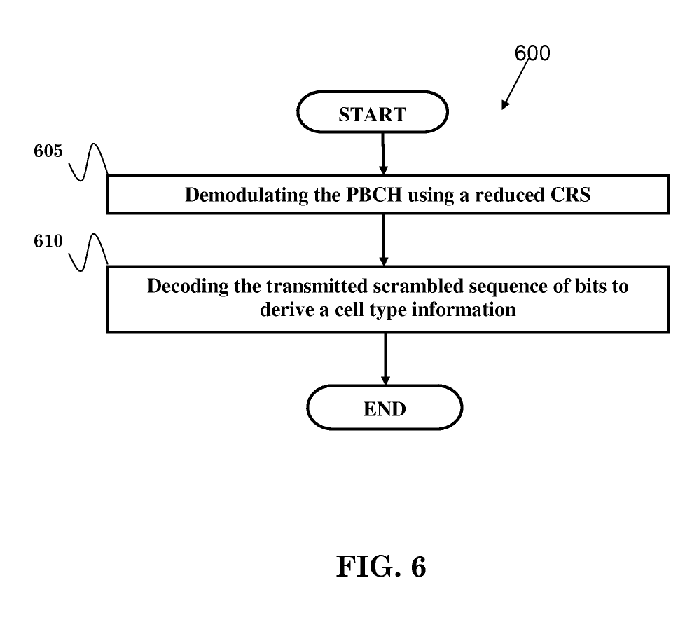

FIG. 6 is a flow chart 600 in accordance with one exemplary embodiment. In step 605, the PBCH is demodulated using a reduced CRS. In step 610, the transmitted scrambled sequence of bits is decoded to derive the cell type information. In general, a scrambled sequence of bits transmitted on a PBCH for a standalone NCT would be different than a scrambled sequence of bits transmitted on a PBCH for a backward-compatible carrier. Furthermore, the scrambled sequence of bits for the standalone NCT could be initialized with a physical layer cell identity and other specified values/parameters. In one embodiment, the scrambled sequence of bits for the standalone NCT could be decoded and derived from performing a left or right bit shift of the scrambled sequence for the backward-compatible carrier. In an alternative embodiment, the scrambled sequence of bits for the standalone NCT could be the inverse sequence of the scrambled sequence for the backward-compatible carrier.

Referring back to FIGS. 3 and 4, the device 300 could include a program code 312 stored in memory 310 to implement NCT. In one embodiment, the CPU 308 could execute the program code 312 to enable a second UE (i) to transmit a scrambled sequence of bits on a PBCH for a standalone NCT, and (ii) to decode the transmitted scrambled sequence of bits to derive a cell type information. Furthermore, the PBCH could be demodulated using a reduced CRS.

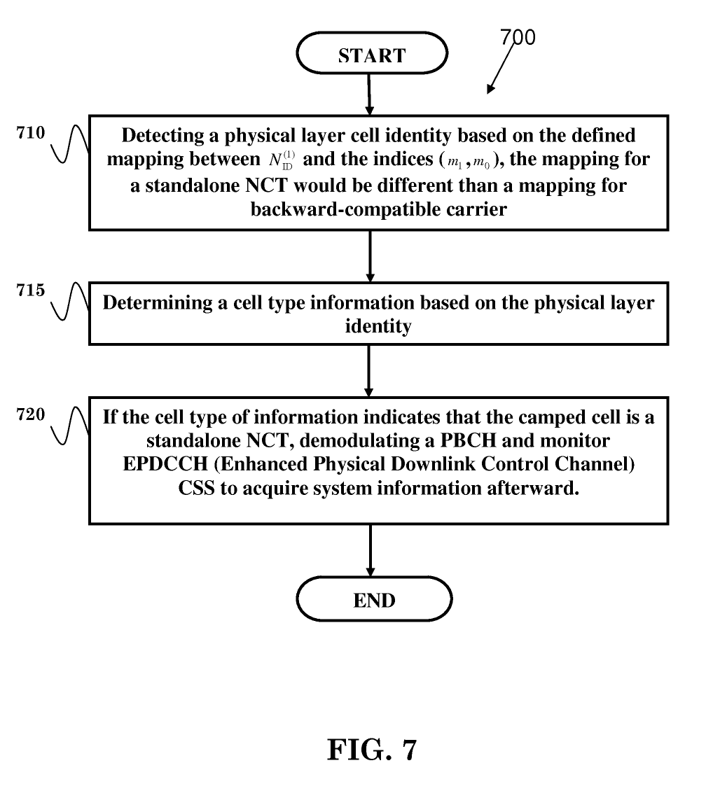

Returning to FIG. 7, in step 710, a physical layer cell identity is detected based on the defined mapping between N_{ID}⁽¹⁾ and the indices (m₁,m₀), wherein the mapping is defined such that for a given physical layer identity group the mapping for a standalone NCT would be different than a mapping for backward-compatible carrier. In one embodiment, for a given physical layer cell identity group N_{ID}⁽¹⁾, the standalone NCT and the legacy backward-compatible carrier are mapped to different value regions of the indices (m₁,m₀). Furthermore, the mapping between N_{ID}⁽¹⁾ and the indices (m₁,m₀) of secondary synchronization signal (SSS) for the standalone NCT is specified.

In step 715, a cell type information is determined based on the mapping between N_{ID}⁽¹⁾ and the indices (m₁,m₀). In step 720, if the cell type of information indicates that the camped cell is a standalone NCT, demodulating a PBCH and monitor EPDCCH (Enhanced Physical Downlink Control Channel) CSS to acquire system information afterward. In one embodiment, the PBCH could be demodulated by a reduced CRS (Cell-specific Reference Signal). Alternatively, the PBCH could be demodulated by a DM-RS (Demodulation Reference Signal).

In one embodiment, some information about the EPDCCH CSS could be included in a MIB (Master Information Block) of the standalone NCT. Furthermore, phich-Config (a field of PHICH configuration) could be used to deliver the information about the EPDCCH CSS.

Referring back to FIGS. 3 and 4, the device 300 could include a program code 312 stored in memory 310 to implement NCT. In one embodiment, the CPU 308 could execute the program code 312 to enable a second UE (i) to define a mapping between N_{ID}⁽¹⁾ and the indices (m₁,m₀) such that for a given physical layer identity group the mapping for a standalone NCT would be different than a mapping for backward-compatible carrier, (ii) to determine a physical layer cell identity based on the defined mapping between N_{ID}⁽¹⁾ and the indices (m₁,m₀), (iii) to determining a cell type information based on the mapping between N_{ID}⁽¹⁾ and the indices (m₁,m₀), and (iv) if the cell type of information indicates that the camped cell is a standalone NCT demodulating a PBCH and monitor EPDCCH CSS to acquire system information afterward. In addition, the CPU 308 could execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for implementing New Carrier Type (NCT), comprising:
including a PDCCH (Physical Downlink Control Channel) for a standalone NCT located in part of DL (Downlink) bandwidth, wherein bandwidth for the PDCCH is indicated in a MIB (Master Information Block) field.

2. The method of claim 1, wherein the MIB field is dl-Bandwidth.

3. The method of claim 1, wherein the DL bandwidth configuration of the standalone NCT and/or the Enhanced Physical Downlink Control Channel (EPDCCH) Common Search Space (CSS) are included in a SIB (System Information Block).

4. The method of claim 1, further comprises:
demodulating the PDCCH using the reduced CRS within the indicated bandwith for the PDCCH, wherein a reduced CRS (Cell-specific Reference Signal) is transmitted in subframes 0 and 5.

5. The method of claim 1, wherein the PDCCH region exists only subframes 0 and 5.

6. The method of claim 1, wherein a resource-mapping of PCFICH (Physical Control Format Indicator Channel) is derived by the bandwidth of the PDCCH region instead of the DL bandwidth configuration of the standalone NCT.

7. The method of claim 1, wherein a number of PHICH (Physical Hybrid ARQ Indicator Channel) groups is derived by the bandwidth of the PDCCH region instead of the DL bandwidth configuration of the standalone NCT, and the PHICH transmission is within the bandwidth of the PDCCH region.

8. A method for implementing New Carrier Type (NCT), comprising:
decoding the transmitted scrambled sequence of bits to derive a cell type information.

9. The method of claim 8, wherein the scrambled sequence of bits transmitted on a PBCH for a standalone NCT is different than a scrambled sequence of bits transmitted on a PBCH for a backward-compatible carrier

10. The method of claim 8, wherein the scrambled sequence of bits for the standalone NCT could be initialized with a physical layer cell identity and/or another specified value/parameter.

11. The method of claim 8, wherein the scrambled sequence of bits for the standalone NCT is decoded and derived from performing a left or right bit shift of the scrambled sequence for the backward-compatible carrier.

12. The method of claim 8, wherein the scrambled sequence of bits for the standalone NCT is the inverse sequence of the scrambled sequence for the backward-compatible carrier.

13. The method of claim 8, further comprising:
demodulating the PBCH using a reduced CRS (Cell-specific Reference Signal).

14. A method for implementing New Carrier Type (NCT), comprising:
detecting a physical layer cell identity based on the defined mapping between N_{ID}⁽¹⁾ and the indices (m₁,m₀), wherein the mapping is defined such that for a given physical layer identity group the mapping for a standalone NCT would be different than a mapping for backward-compatible carrier; and
determining a cell type information based on the mapping between N_{ID}⁽¹⁾ and the indices (m₁,m₀).

15. The method of claim 14, wherein for a given physical layer cell identity group N_{ID}⁽¹⁾ the standalone NCT and the legacy backward-compatible carrier are mapped to different value regions of the indices (m₁,m₀).

16. The method of claim 14, wherein the mapping between N_{ID}⁽¹⁾ and the indices (m₁,m₀) of secondary synchronization signal (SSS) for the standalone NCT is specified.

17. The method of claim 14, wherein the PBCH is demodulated by a reduced CRS (Cell-specific Reference Signal), and/or by a DM-RS (Demodulation Reference Signal).

18. The method of claim 14, wherein information about the EPDCCH CSS is included in a MIB (Master Information Block) of the standalone NCT.

19. The method of claim 14, wherein phich-Config is used to deliver the information about the EPDCCH CSS.

20. The method of claim 14, further comprises:
if the cell type of information indicates that the camped cell is a standalone NCT, demodulating a PBCH and monitor EPDCCH (Enhanced Physical Downlink Control Channel) CSS (Common Search Space) to acquire system information afterward.
